(19) United States
(12) Patent Application Publication
(10) Pub. No.: US 2018/0165417 A1
(43) Pub. Date: Jun. 14, 2018

(54) Bathroom Telemedicine Station

(71) Applicants: David R. Hall, Provo, UT (US); Dan Allen, Springville, UT (US); Ben Swenson, Lehi, UT (US)

(72) Inventors: David R. Hall, Provo, UT (US); Dan Allen, Springville, UT (US); Ben Swenson, Lehi, UT (US)

(21) Appl. No.: 15/378,301

(22) Filed: Dec. 14, 2016

(51) Int. Cl. G06F 19/00

(52) U.S. Cl. CPC G06F 19/3418; G06F 19/322; G06F 19/345; G06F 19/3456

(57) ABSTRACT

We disclose a telemedicine station for providing healthcare services outside of a staffed healthcare facility. The telemedicine station may include an audiovisual device through which a user may communicate with a remote healthcare provider. The telemedicine station may include cabinets with multiple compartments. The compartments may house medical devices that are adapted for an untrained user to operate. The telemedicine station may include a medical toilet which collects and analyzes urine and fecal samples. Other compartments house medical supplies which may include prescription medication. A user may receive authorization to access a compartment that houses a medical supply based on the results of the health metric and/or discussion with the remote healthcare provider. The telemedicine station and the compartments may require a user to be given access permission to open a compartment. The telemedicine station may include a compartment to deposit unused medications for destruction.

### BACKGROUND

### Field of the Invention

This disclosure relates to equipment and methods for dispensing medical supplies through an automated system.

### Background of the Invention

Many people find that visiting a healthcare provider in a clinic or doctor's office takes too much time and is inconvenient. In addition, some people require medical services that are not available to them without significant travel and expense. For these reasons, medical services provided remotely are more commonly available. This practice is called “telemedicine”.

In some instances, telemedicine involves seeing a healthcare provider that is local to the patient who conducts diagnostic tests. The results of the tests are transmitted to a medical specialist who consults with the local healthcare provider to develop a treatment plan for the patient.

However, even seeing a local healthcare provider is inconvenient for some people and for some, there is no local healthcare provider. In these situations, people may postpone seeking medical services. A mechanism to provide telemedicine services in a manner in which there is no need to travel to a staffed clinic or hospital is needed.

### BRIEF SUMMARY OF THE INVENTION

We disclose a bathroom telemedicine station through which a user may receive medical diagnosis and treatment completely through telemedicine methods. The telemedicine station includes a private room with a lockable door. Users with valid access privileges may present a valid user identification credential to a user identification system which unlocks the lockable door. The user may enter the telemedicine station and communicate with a healthcare provider who is located at a remote healthcare facility. The telemedicine station includes a first cabinet that includes multiple compartments for housing one or more medical devices. The medical devices are adapted to be used by an untrained user without assistance or under the direction of the remote healthcare provider who communicates through an audiovisual device. The telemedicine station also may include a medical toilet which may collect health metrics. The medical toilet may collect and analyze urine and fecal samples as well as collect other health metrics. The telemedicine station may include one or more communication ports which may transmit the results of the health metrics to the remote healthcare provider. With the aid of the health metric data, the remote healthcare provider may authorize specific medical supplies, including, but not limited to, prescription medication. A second cabinet within the telemedicine station, also with multiple lockable compartments may house one or more medical supplies. The user may open the appropriate compartment, again using user identification credentials, and retrieve the authorized medical supply. The user has thus received a complete office visit including diagnosis and treatment completely through telemedicine. The disclosed telemedicine station will provide convenient healthcare to those who would not otherwise have access to healthcare services and to those who would otherwise avoid seeking healthcare because of the inconvenience of traditional healthcare services.

### BRIEF DESCRIPTION OF THE DRAWINGS

FIG. 1 is an isometric view of an embodiment of the disclosed bathroom telemedicine station.

FIG. 2A is an embodiment of a user identification system according to an embodiment of the disclosed bathroom telemedicine station receiving a signal from a mobile device.

FIG. 2B is an embodiment of a user identification system according to an embodiment of the disclosed bathroom telemedicine station which includes a numerical keypad.

FIG. 3 is an embodiment of an audiovisual communication device with a lockable barrier according to an embodiment of the disclosed bathroom telemedicine station sending a transmission to a remote healthcare facility.

FIG. 4 is a cabinet according to an embodiment of the disclosed bathroom telemedicine station with a compartment housing diagnostic equipment.

FIG. 5 is a cabinet according to an embodiment of the disclosed bathroom telemedicine station with a compartment housing medical supplies.

FIG. 6 is a medical toilet according to an embodiment of the disclosed bathroom telemedicine station which is collecting health metrics from a user.

FIG. 7 is another embodiment of the medical toilet according to an embodiment of the disclosed bathroom telemedicine station.

FIG. 8A is a compartment housing a medication with a signal indicating the presence of the medication in the compartment.

FIG. 8B is the compartment of FIG. 8A after a user has removed the medication and the signal has been sent to indicate absence of the medication.

FIG. 9A is a user identification signal being received by a cabinet that houses medical devices.

FIG. 9B is a remote healthcare facility sending a signal to a cabinet that houses medical supplies.

FIG. 9C is a user identification signal being received by the cabinet of FIG. 9B.

FIG. 10 is a flow chart which illustrates an embodiment of a method of using the disclosed bathroom telemedicine station.

### DETAILED DESCRIPTION OF THE INVENTION

### Definitions

Toilet, as used herein, means a device that collects biological waste products of a mammal, including urine and feces.

Medical toilet, as used herein, means a toilet that conducts one or more measurements relevant to a user's health status. This may include, but is not limited to, quantification of analytes in urine or feces, cardiovascular parameters, bioimpedance measurements, and body weight.

User, as used herein, means any mammal, human or animal, for which the bathroom telemedicine station disclosed herein is used to provide healthcare services.

Healthcare provider, as used herein, means any individual who performs a task, mental or physical, in relation to health-related services provided to a user. In addition to clinicians who practice medicine directly on a user, the term healthcare provider includes any person that enters data into a computer, when the data entry is used in analysis of a user's health status or to improve a user's health.

Access permission, as used herein, means valid user identification means including, but not limited to, names, numerical codes, passwords, instructions, keys, authentication tokens, ciphers, deciphers, public keys, valid access times, certificates, or other means known in the art for determining whether a user is authorized to access the telemedicine station or a compartment within the telemedicine station.

While this invention is susceptible of embodiment in many different forms, there are shown in the drawings, which will herein be described in detail, several specific embodiments with the understanding that the present disclosure is to be considered as an exemplification of the principals of the invention and is not intended to limit the invention to the illustrated embodiments.

We disclose a telemedicine station that may be integrated with an American Disabilities Act (ADA) bathroom or similar room. The telemedicine station may be a single user bathroom for male or female or family, handicap accessible, and include a lockable door providing privacy while the user communicates with a remote healthcare provider, collects health metrics from medical devices, retrieves medical supplies for treatment. The disclosed telemedicine station may be placed, for example, in rural areas that do not have significant healthcare facilities nearby, at various locations around more populated cities to provide a fast and convenient source of medical care, and in workplaces as part of employee health benefits. The telemedicine station may be used to provide basic general healthcare for preventative healthcare or minor injuries and illnesses. The telemedicine station may also enable a user to monitor a more serious and/or specialized injury or illness from a location near the user's home without the need to remain near a specialty clinic.

In some embodiments, the telemedicine station includes a room with a lockable door. In some embodiments, a specific, authorized user may unlock the door through a user identification system. The user identification system may be a device that receives a signal associated with a specific user through Bluetooth beacon proximity detection, a personal identification code entered by a user, radio frequency identification of a user's mobile device, biometric verification, or other means known in the art. In some embodiments, the biometric verification method is a user's fingerprint which may be read by a device on the door. Some embodiments include a user identification system that may identify a user through more than one of these methods.

The telemedicine station may include an audiovisual communication device through which a user may communicate with a remotely located healthcare provider. Just as would occur in a face-to-face clinic visit, the user may discuss appropriate diagnostic metrics to collect, some or all of which may be collected using medical devices located within the telemedicine station. The user may also discuss appropriate treatment options using medical supplies which may also be located within the telemedicine station. Controlled lighting or coded color targeting for color balancing may improve the quality of the visual transmission the audiovisual communication device send to the remote healthcare provider. This may improve diagnosis of skin rashes and other illness that may be diagnosed, at least in part, through visual assessment.

The audiovisual device may be connected to a communication port which may be wired or wireless, to enable a user and a remote healthcare provider to communicate. The audiovisual device may also include a lockable barrier. The lockable barrier may be electronically connected to a remote healthcare facility. A healthcare provider at the remote healthcare facility may unlock the lockable barrier remotely to communicate with a user.

The telemedicine station may include a first cabinet that has multiple lockable compartments, similar to a cabinet that houses multiple mailboxes. Each compartment may be unlocked individually from a remote distribution source. The remote distribution source may be a remote healthcare facility with which the user communicates through the audiovisual device. In some embodiments, the compartments may be unlocked by sending access permissions that may be unique to that user. The compartments may contain one or more medical devices which have been adapted or designed for ease of use by an untrained user. The user may open the appropriate compartment(s) and retrieve the medical device(s) as directed by the remote healthcare provider. The medical device(s) may be connected to a communication port which may transmit the health metric from the medical device(s) to a remote healthcare facility.

In some embodiments, a user may visit the telemedicine station routinely to monitor an existing condition. In such situations, the user may not need to communicate with a remote healthcare provider during each visit but may only need to collect a health metric with a particular medical device. In this situation, the user may have continued access permission to unlock the compartment that houses the particular medical device. The user may enter the telemedicine station at a convenient time which may be any time the user needs to collect the health metric.

The compartments may include a variety of medical devices known in the art including, but not limited to, a glucometer, a blood analyzer, an otoscope, a stethoscope, a blood pressure monitor, a body temperature sensor, a pulse oximeter, an ophthalmoscope, and an electrocardiogram unit, an ultrasound device, a test strip, a test strip reader, a tissue imager. In some embodiments, the blood sample analyzer may be a microfluidic blood sample analyzer.

In addition to medical devices housed in the compartments, the telemedicine station may include a medical toilet. A medical toilet may function in a manner that is similar to a conventional toilet except that the medical toilet collects health metrics including analysis of urine and feces. The toilet may also include weight sensors which measure body weight, bioimpedance sensors, heart rate sensor, blood pressure sensors, and body temperature sensors. In some embodiments, the toilet includes a lid, a seat, or both a lid and a seat. Either the lid, the seat, or both may include sensors that collect health metrics. The medical toilet may also be connected to a communication port which may transmit the health metrics to a remote healthcare facility.

In some embodiments, the medical toilet both collects and analyzes urine and fecal samples automatically. In other embodiments, the medical toilet collects urine and fecal samples and preserves them at a low temperature for later collection and analysis. The telemedicine station may also include compartments to refrigerate or freeze samples until they may be collected by a courier and transported for analysis off-site. In some embodiments, the telemedicine station includes a mail or shipping pick-up station from which a courier may collect samples for transport.

The medical toilet in the telemedicine station is unique and particularly useful. Typically, medical exam rooms do not include a toilet. However, a medical toilet is useful for collection of urine and fecal samples and alleviates the need for separate private and sanitary spaces for sample collection and analysis.

The telemedicine station may include a second cabinet which, like the first cabinet, may include multiple lockable compartments. The lockable compartments in the second cabinet may house medical supplies for treatment of a health condition. The medical supplies housed within the compartments may include, but are not limited to, pharmaceutical products, an ultrasound therapy device, an electrostimulation therapy unit, a drug delivery device, first aid supplies, and urinary catheters.

The compartments in the second cabinet may also be unlocked remotely by a remote healthcare provider. For example, the healthcare provider may direct the user to collect a health metric using a medical device housed in one of the compartments in the first cabinet. The health metric may be transmitted to the remote healthcare provider who analyzes the data and offers a treatment plan. The healthcare provider may then unlock a particular compartment by sending access permissions that may be unique to that user.

The second cabinet may also include a user identification system which may include Bluetooth beacon proximity detection, a personal identification code, radio frequency identification of a user's mobile device, biometric verification, and other means known in the art. In some situations, the user may be given one-time or continued access permission to unlock the compartment that houses the particular medical supply that the user is authorized to receive. In some embodiments, a user may have a dedicated compartment to receive that user's medical supplies. For example, a remote healthcare provider may prescribe a medication to the user which may be delivered to the telemedicine station by a courier at a later date. The user may be notified that the medication has been delivered to the telemedicine station then use the user's access permission to unlock the compartment housing the medication. The compartment housing the user's medication may only be unlocked upon identification of a valid user, in this case, the user that has been prescribed the medication in the compartment. In some embodiments, the access permission may be periodically activated to enable a user to retrieve a prescription refill at defined intervals. The user may also have continuous access permission to retrieve certain medical supplies. For example, a user may be given access permission to retrieve urinary catheters any time the user needs them.

Both the first and the second cabinets may include sensors which determine whether the medical device or medical supply respectively is present in the compartment. The communication port may be used to send a signal to a remote site that the compartment needs to be restocked. Also, the sensor may indicate, along with a record of the use of access permissions, whether a user has retrieved the contents of the compartment. The sensors may be weight sensors, optical sensors, acoustic sensors, and other proximity sensors known in the art.

In some embodiments, the first cabinet and the second cabinet are combined into a single cabinet. In this embodiment, the compartments may or may not be separated into a first section of compartments that houses medical devices and a second section of compartments that houses medical supplies.

In some embodiments, the compartments that house medical devices and medical supplies may each include a one-way door through which a courier may deposit the desired contents but the contents may not then be retrieved through the one-way door.

The compartments may include means for assuring that the proper medical supply is deposited in the proper compartment. For example, the container or packaging surrounding the medical supply, may include a radiofrequency identification (RFID) tag to verify that the medical supply has been placed in the proper compartment. If an unauthorized RFID tag is placed in a compartment, a user's access permission may not be accepted and the compartment will not unlock when the user presents the access permission to the compartment.

In some embodiments, the compartments house first aid equipment. In some embodiments, when a user accesses certain types of first aid equipment, the appropriate on-line worker's compensation forms may be prefilled with appropriate information and remaining information transcribed from voice to text as the user answers questions. The questions may be provided and answered through an application on the user's smart phone. For example, the questions may include the following: “describe the medical condition needing treatment,” “describe the circumstances that led to acquire the medical condition,” “describe what medical treatment was provided,” or “do you desire additional medical assistance?” In the case of the last question, an affirmative answer may direct a healthcare provider to call the user or communicate with the user through the audiovisual device in the telemedicine station. The healthcare provider may send an ambulance or other local medical response unit to assist the user.

The cabinet may provide a secure way to dispose of unwanted medicines. In some embodiments, users may take an RFID tag and apply it to a bottle of unused medication, apply tamper tape to the lid or packaging, and deposit the medication in a compartment in the cabinet. The user may then lock the compartment and request pick up via a mobile device application or electronic display kiosk in the telemedicine station. Alternatively, the user may not request pick up of the medication and a courier may simply check the compartment designated for unused and unwanted medication when periodically visiting the telemedicine station.

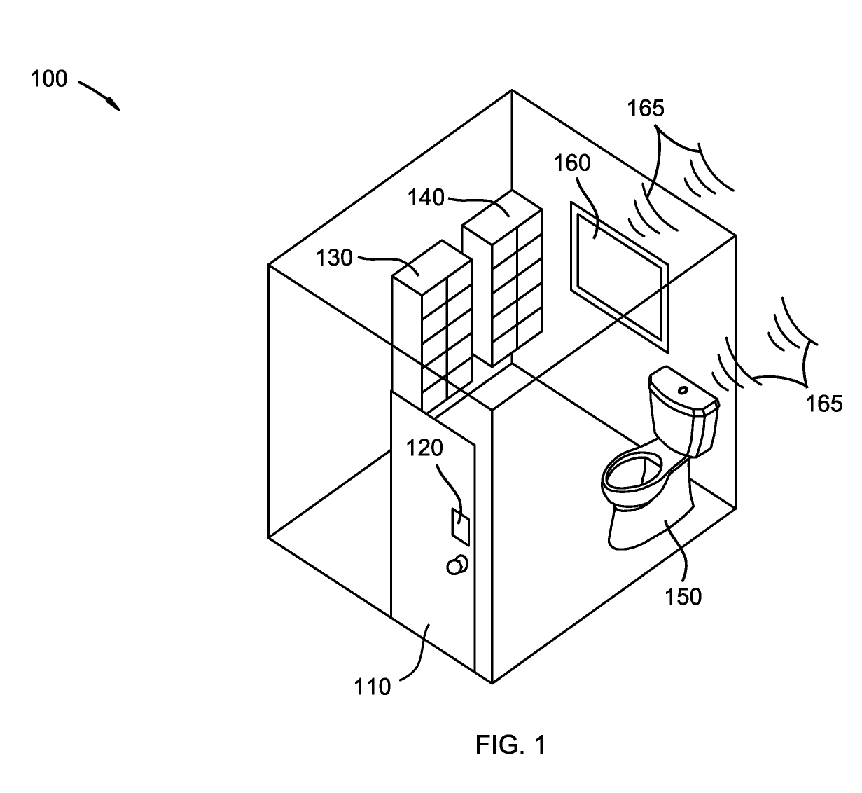

Referring now to the drawings, FIG. 1 illustrates bathroom telemedicine station 100, an embodiment of the disclosed invention. Walls are shown transparent for clarity, although the bathroom telemedicine station may be completely enclosed by opaque walls, floor, and ceiling for user privacy. Door 110 may be lockable and unlockable by an authorized user through user identification system 120. Medical toilet 150 is inside bathroom telemedicine station 100. Various embodiments of medical toilet 150 may perform different health metrics. These may include, but are not limited to, fecal and urine collection and analysis, bioimpedance measurements, body weight measurements, heart rate measurements, blood pressure measurements, and electrocardiogram measurements. Audiovisual device 160 allows a user to communicate through sight and sound with a healthcare provider in a remote location. The healthcare provider and the user may discuss the user's health concerns and the healthcare provider may then direct the user to first cabinet 130. First cabinet 130 includes multiple compartments which house different medical devices. The medical devices are designed to be user-friendly so that the user may conduct a diagnostic test on himself or herself without help or under the direction of the remote healthcare provider communicating through audiovisual device 160. The compartments of first cabinet 130 may be lockable and the remote healthcare provider may unlock a compartment housing the appropriate medical device by sending a remote signal. Alternatively, the remote healthcare provider may enable the user to unlock the appropriate cabinet by sending access permissions to the user which may be unique to that user. The user may then access the appropriate medical device and collect a health metric using the medical device. The medical device may send an electronic signal to the remote healthcare provider communicating the result of the diagnostic test. The user and the remote healthcare provider may then select a treatment plan for the user.

The treatment plan selected for the user may require medical supplies. Second cabinet 140 includes multiple lockable compartments, similar or identical to those of first cabinet 130. The compartments of second cabinet 140 house medical supplies. The remote healthcare provider may again send a remote signal to a particular compartment to unlock the appropriate compartment and give the user access to the appropriate medical supply. Alternatively, the remote healthcare provider may enable the user to unlock the appropriate cabinet by sending access permissions to the user which may be unique to that user. One or more communication ports may place one or more of user identification system 120, first cabinet 130 and compartments therein, second cabinet 140 and compartments therein, medical toilet 150, and audiovisual device 160 in communication with a remote source which may include a remote healthcare facility or a security center. For example, first cabinet 130 and second cabinet 140 may both receive signals to allow a user to open a particular compartment and send signals to a remote location indicating that a particular compartment has been opened. Sensors within the compartments may indicate when its contents have been removed. As illustrated in FIG. 1, electronic signals 165 are sending a communication from audiovisual device 160 and medical toilet 150.

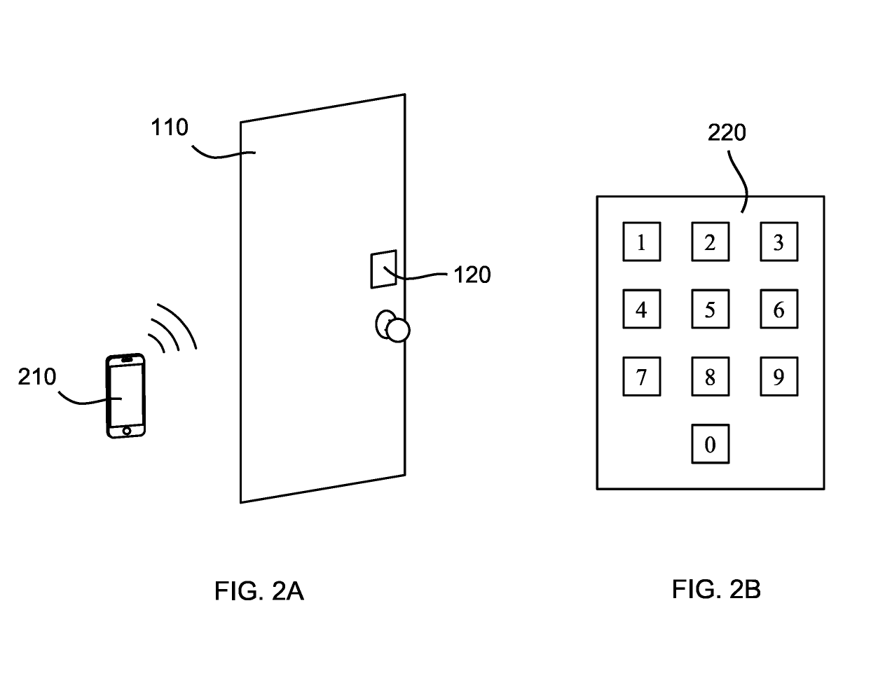

FIG. 2A illustrates an embodiment of door 110 first presented in FIG. 1. Door 110 includes user identification system 120. In this embodiment, a signal from mobile device 210 sends a radio frequency identification signal to user identification system 120 to identify the user. If the user is authorized to enter the telemedicine station, user identification system 120 may unlock door 120.

FIG. 2B is a close-up view of an embodiment of a keypad 220 that may be part of an embodiment of a user identification system. A user may enter a personal identification number (PIN) to unlock the door of the telemedicine station. Some embodiments may include both a keypad and receive radiofrequency signals or Bluetooth beacon proximity detection. Biometric readings may also be used in some embodiments of the user identification system. For example, the user identification system may scan a user's fingerprint, retina, or conduct facial or voice recognition analysis of a user.

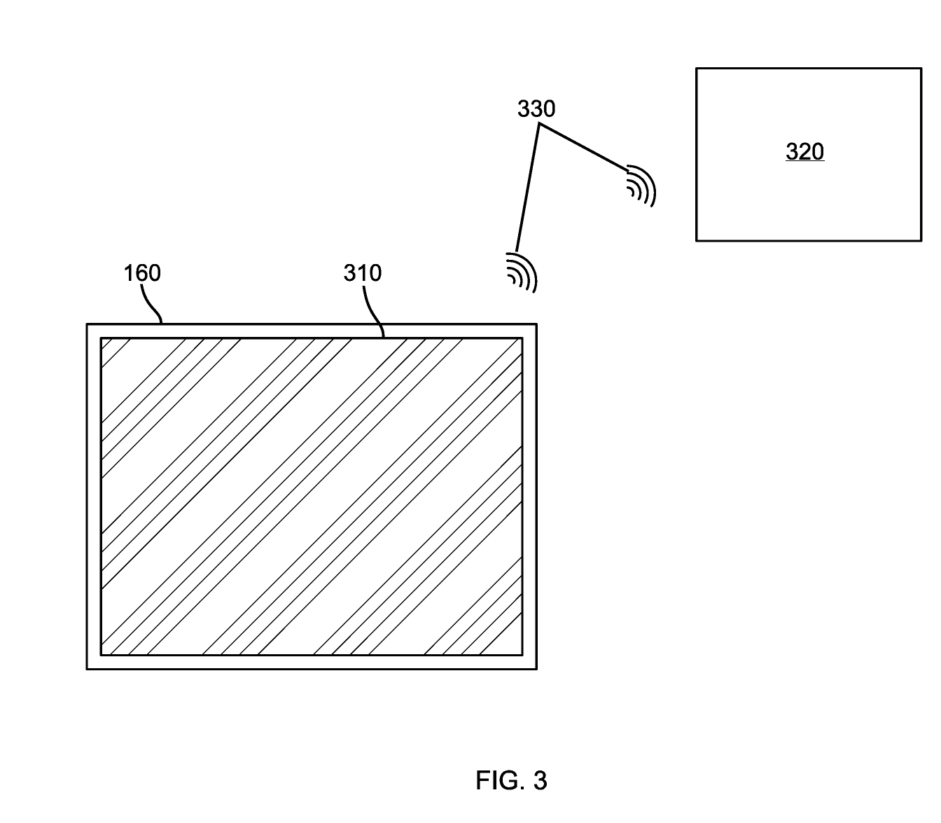

FIG. 3 illustrates a close-up of audiovisual device 160 first presented in FIG. 1. This embodiment of the audiovisual device includes lockable barrier 310. In some embodiments, lockable barrier 310 may be a slidable screen or cover that removably covers a screen of the audiovisual device. A healthcare provider at the remote healthcare facility may lock and unlock the lockable barrier remotely by sending a signal to the lockable barrier. Alternatively, a valid user may be given access permissions to unlock the lockable barrier similar to the access permissions that may be given to unlock the door to the telemedicine station or compartments in the first and second cabinets. Audiovisual device 160 may be connected to a communication port which transmits signals 330 between audiovisual device 160 and remote healthcare facility 320. Not only do these signals lock and unlock lockable barrier 310, but also enable communication between a user and a remote healthcare provider who may be at remote healthcare facility 320.

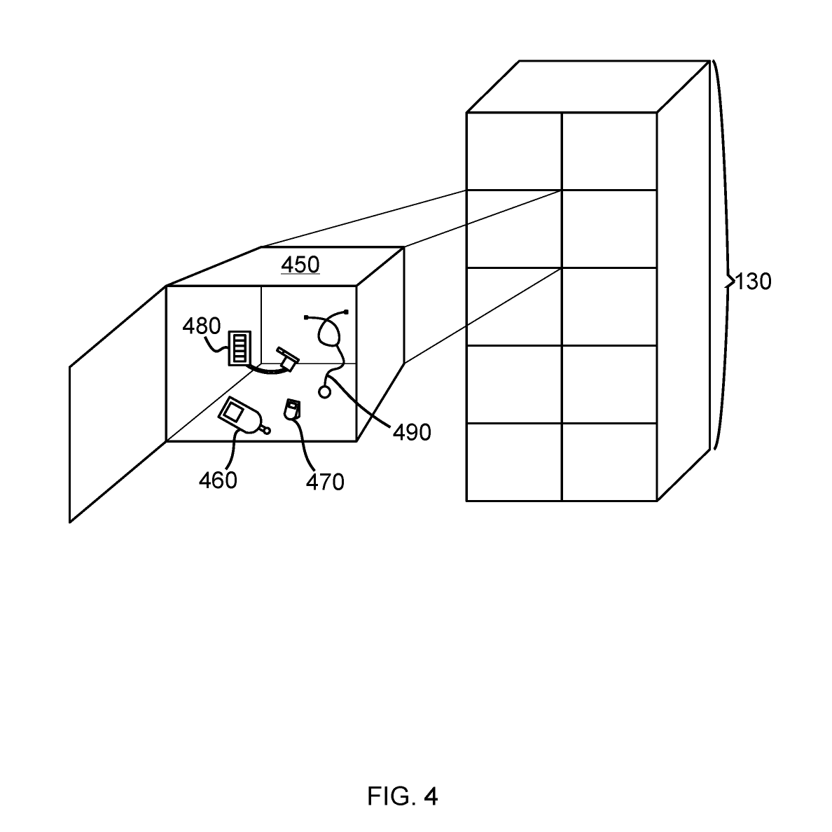

FIG. 4 illustrates an embodiment of first cabinet 130. The illustration includes an expanded illustration of compartment 450 of first cabinet 130. Compartment 450 includes multiple medical devices. The contents of compartment 450 include glucometer 460, pulse oximeter 470, respirometer 480, and stethoscope 490. Other medical devices may be housed in the compartments of first cabinet 130. Also, compartment 450 could house a single medical device.

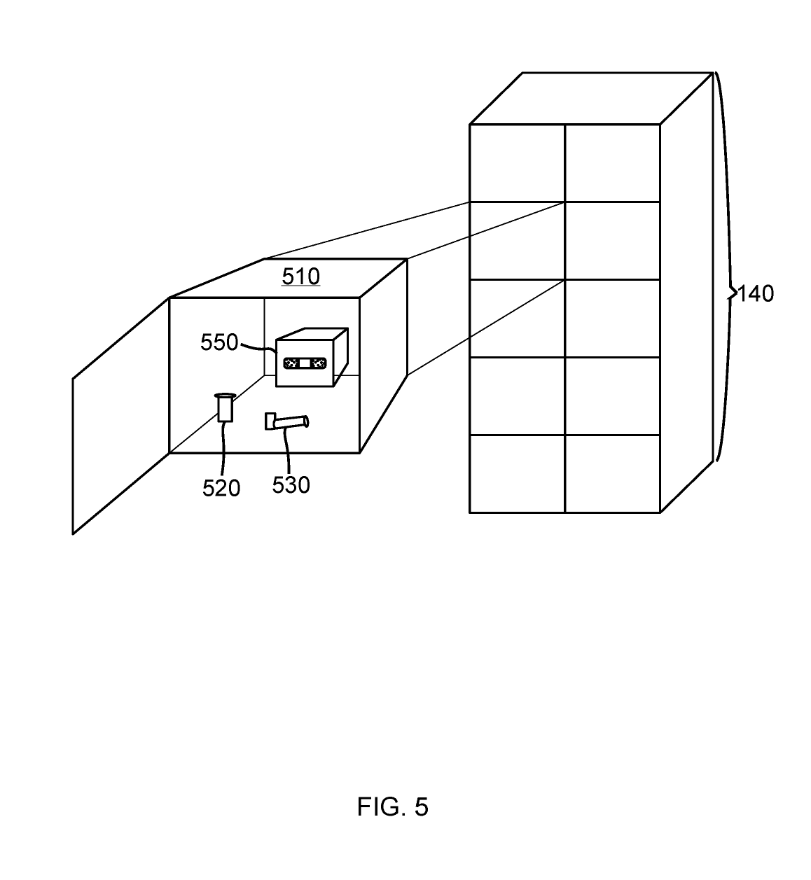

FIG. 5 illustrates an embodiment of second cabinet 140. The illustration includes an expanded illustration of compartment 510 of second cabinet 140. Compartment 510 includes multiple medical supplies including prescription medicine 520, inhaler 530, and box of bandages 550. Other medical supplies may be housed in the compartments of second cabinet 140. Also, compartment 510 could house a single medical supply.

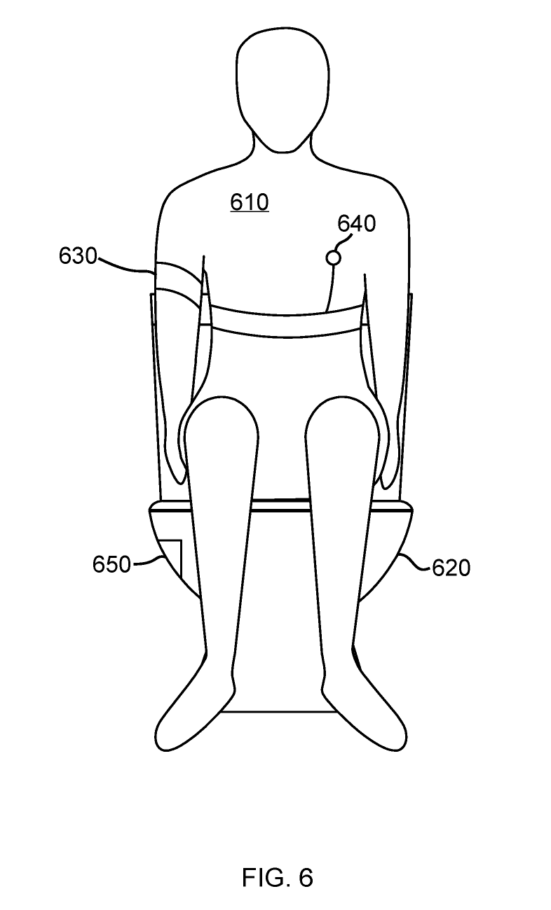

FIG. 6 illustrates user 610 collecting medical metrics on medical toilet 620 within a telemedicine station. User 610 is shown conducting a blood pressure measurement using blood pressure monitor 630, collecting a heart rate measurement using stethoscope 640, and having a urinalysis conducted using urinalysis device 650. Medical toilet 620 may include any combination of these and/or other medical devices all of which are within the scope of this disclosure.

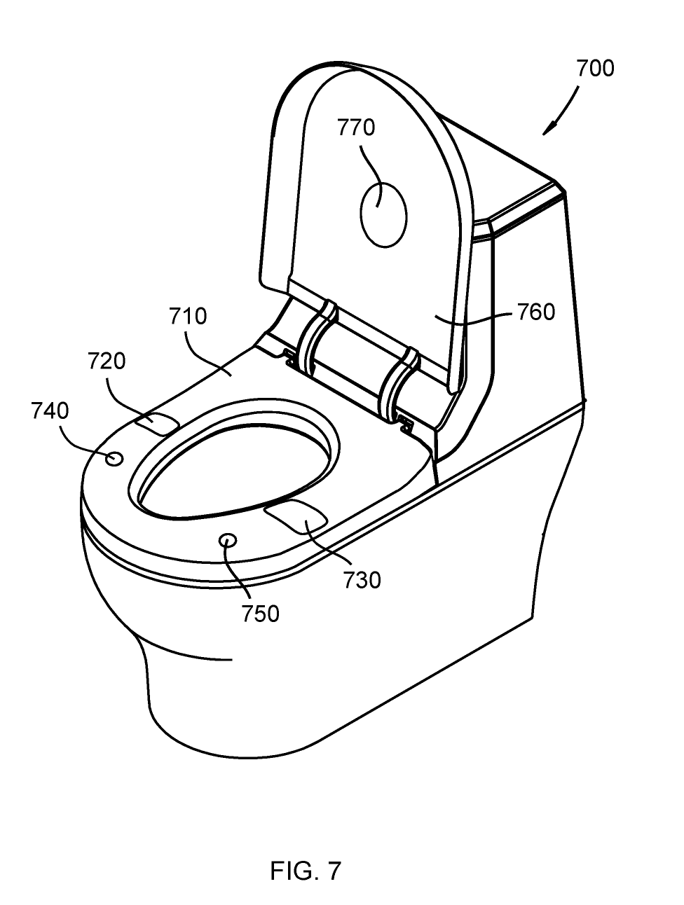

FIG. 7 illustrates medical toilet 700, which is another embodiment of the medical toilet that may be included in the disclosed telemedicine station. Seat 710 includes pressure sensors 720 and 730 which may measure a user's body weight. Seat 710 also includes bioimpedance sensors 740 and 750 which may be used to collect a variety of health metrics including percent body fat.

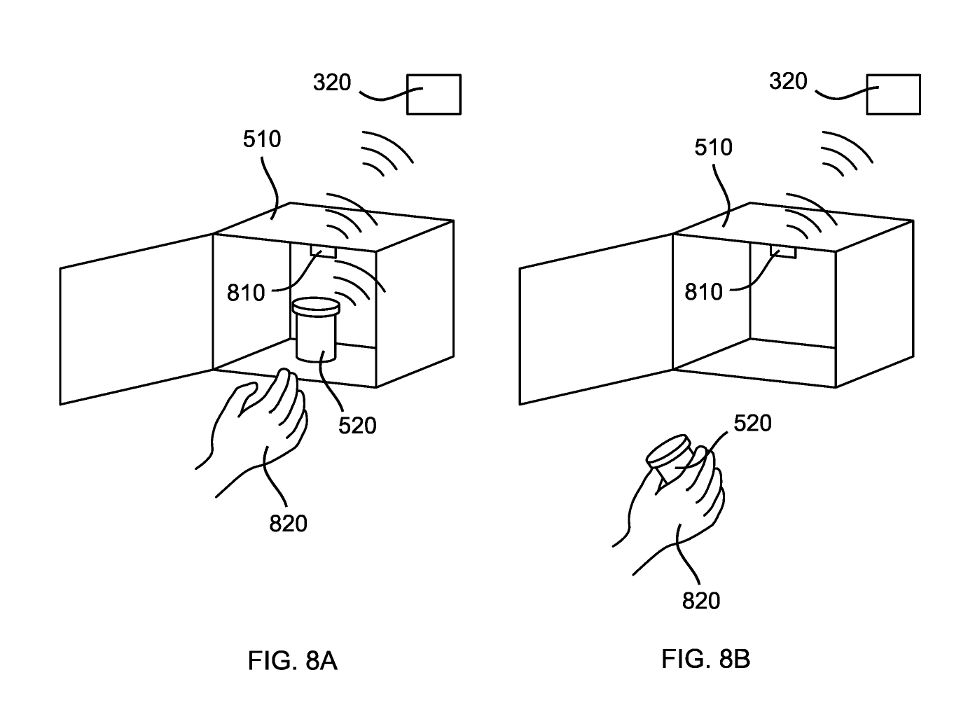

FIG. 8A illustrates an embodiment of user 820 receiving a medical supply from compartment 510, which was first presented in FIG. 5 as a compartment within second cabinet 140. In the embodiment of FIG. 8A, compartment 510 includes a mechanism for determining the presence or absence of the appropriate medical supply within compartment 510. The medical supply of FIG. 8A is shown as prescription medicine 520. User 820 (the user's hand only is shown for simplicity) has gained access to the contents of compartment 510 by means discussed elsewhere herein. An RFID tag is on or in the bottle housing prescription medicine 520 and scanner 810 detects the presence of prescription medicine 520 by detecting the RFID signal. An electronic signal may be sent to remote healthcare facility 320 indicating the presence of prescription medicine 520 inside compartment 510.

FIG. 8B illustrates the embodiment of FIG. 8A in which user 820 has retrieved prescription medicine 520 from compartment 510. Scanner 810 senses the absence of the RFID tag associated with prescription medicine 520 and sends an electronic signal to healthcare facility 320 indicating the absence of prescription medicine 520 from compartment 510. The signal sent to remote healthcare facility 320 indicates that a user has received the proper prescription medication and that it may be necessary to restock compartment 510. Other sensors may be used to indicate presence or absence of medical supplies in compartments, including, but not limited to, a weight sensor programmed to assess whether the object on the weight sensor is of the weight expected for the appropriate medical supply.

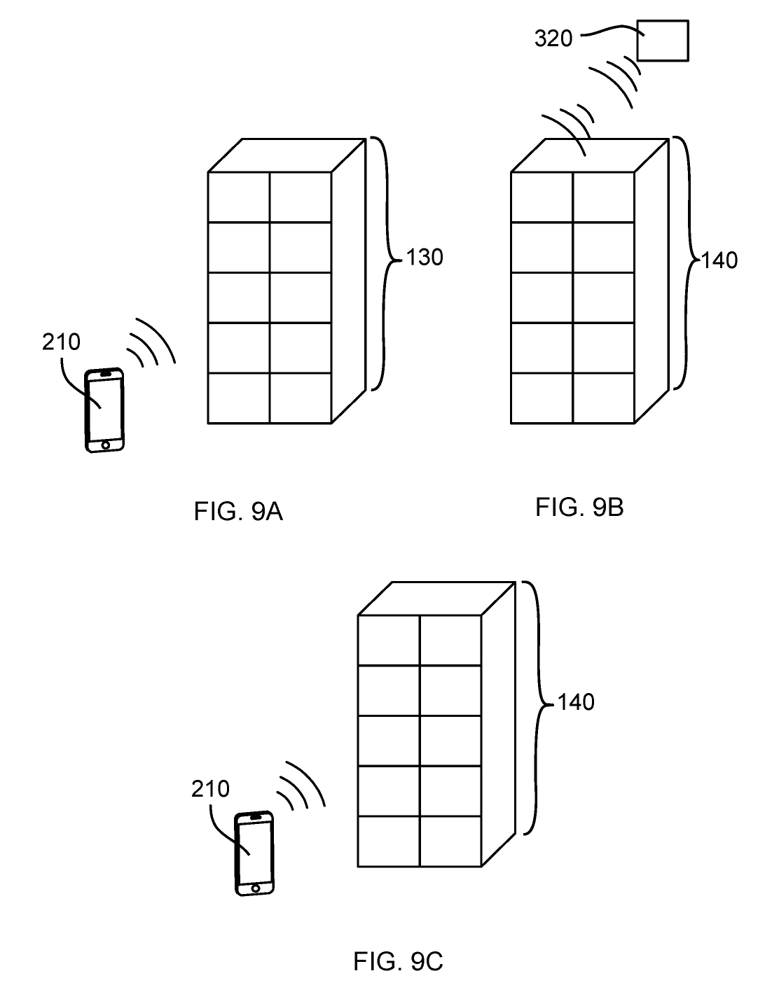

FIGS. 9A-9C illustrate a process through which a user's mobile device may interface with an embodiment of a user identification system to access medical devices within first cabinet 130 and medical supplies within second cabinet 140. FIG. 9A illustrates mobile device 210 being placed in proximity of first cabinet 130. Mobile device 210 emits a radiofrequency which provides the identity of the user. A user identification system indicates that the user is a valid user of one or more medical devices housed in one or more compartments of first cabinet 130. The appropriate compartments may unlock in response to the radiofrequency and its verification of a valid user.

FIG. 9B illustrates second cabinet 140 receiving a signal from remote healthcare facility 320. At this point, the user may have collected a health metric using a medical device from first cabinet 130 and a remote healthcare provider in remote healthcare facility 320 may have received the data from the health metric. FIG. 9B illustrates a signal emanating from remote healthcare facility 320 which provides the user with access to one or more compartments in second cabinet 140 upon proper user identification.

FIG. 9C illustrates mobile device 210 being placed in proximity of second cabinet 140. Mobile device 210 again emits a radiofrequency which provides the identity of the user. A user identification system indicates that the user is a valid user of one or more medical supplies housed in one or more compartments of second cabinet 140. The appropriate compartments may unlock in response to the radiofrequency and its verification of a valid user allowing the user to retrieve the appropriate medical supplies.

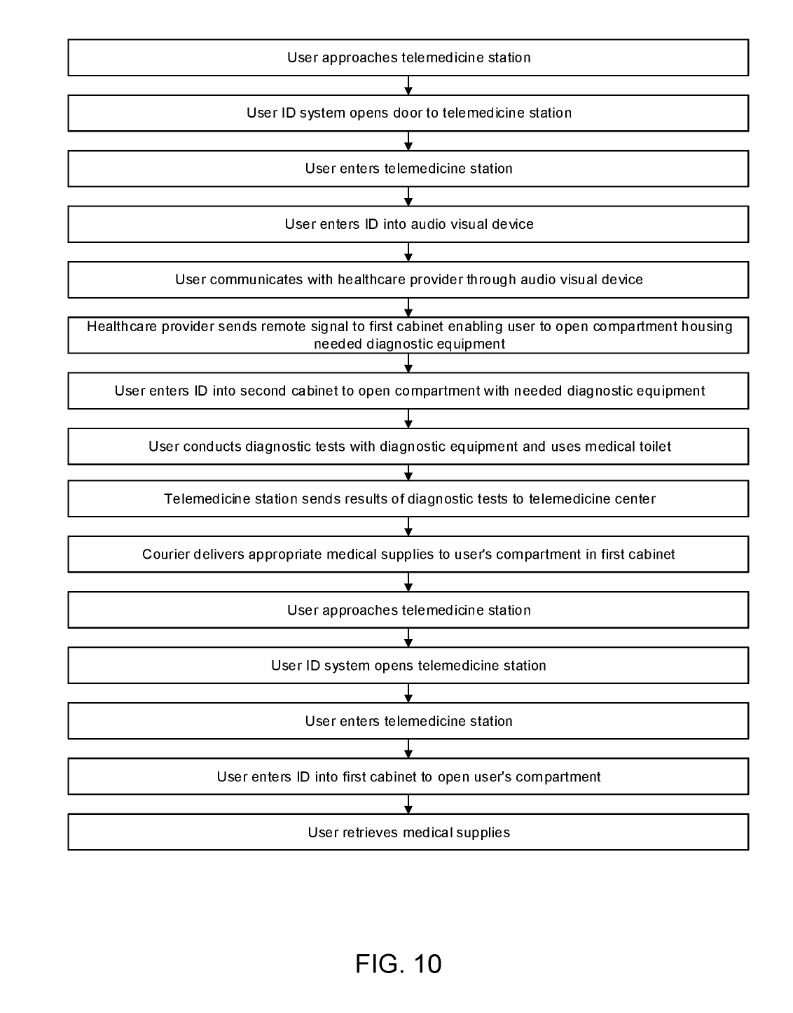

FIG. 10 is a flow chart illustrating an embodiment of a method of using the disclosed telemedicine station. In this embodiment, a user approaches the telemedicine station and is confirmed as a valid user by a first user identification system. The door to the telemedicine station unlocks and the user enters the telemedicine station. At this point, the user wishes to discuss a medical concern with a remote healthcare professional. The user enters a user ID into the audiovisual device which unlocks the lockable barrier. and initiates contact with a remote healthcare provider at a remote healthcare facility. The remote healthcare provider determines that a health metric would be useful in diagnosing the user's health problem. The remote healthcare provider sends a remote signal to the first cabinet which either directly unlocks a compartment within the first cabinet or allows the user to enter a user ID into the first cabinet and unlock a compartment housing the appropriate medical device. Upon retrieving the medical device and collecting a health metric which is transmitted to the remote healthcare provider, the remote healthcare provider proposes a treatment plan that includes the use of medical supplies. In this embodiment, the appropriate medical supply is not available within the telemedicine station. A courier receives an order and delivers the user's medical supplies to the telemedicine station. Upon receiving notification that the medical supplies are now available in the telemedicine station, the user again approaches the telemedicine station and presents a user ID to unlock the door. The user enters the telemedicine station and presents a user ID to a second user identification system associated with second cabinet 140. The compartment within cabinet 140 which houses the user's prescribed medical supplies unlocks and the user retrieves the medical supplies. The medical supplies may be resupplied to the user, for example, in the form of a prescription refill, using the same or similar series of steps.

While specific embodiments have been illustrated and described above, it is to be understood that the disclosure provided is not limited to the precise configuration, steps, and components disclosed. Various modifications, changes, and variations apparent to those of skill in the art may be made in the arrangement, operation, and details of the methods and systems disclosed, with the aid of the present disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that changes may be made to the details of the above-described embodiments without departing from the underlying principles of the disclosure herein.

We claim:

1. A telemedicine station comprising:
a room comprising a lockable door;
a medical toilet located within the room, the medical toilet comprising at least one device for excrement sample collection and analysis;
a first cabinet comprising a first plurality of lockable compartments for stowing at least one piece of diagnostic equipment, wherein each of the first plurality of lockable compartments is unlockable through a remote mechanism or an access permission;
a second cabinet comprising a second plurality of lockable compartments for stowing one or more medical supplies, wherein each of the second plurality of lockable compartments is unlockable through either the remote mechanism or the access permission;
a first audiovisual communication device; and
a communication port which transmits data from the medical toilet, the at least one piece of diagnostic equipment, and the audiovisual communication device.

2. The telemedicine station of claim 1, wherein the at least one piece of diagnostic equipment comprises one or more of the following: a glucometer, a blood sample analyzer, an otoscope, a stethoscope, a blood pressure monitor, a body temperature sensor, a pulse oximeter, an ophthalmoscope, and an electrocardiogram unit, an ultrasound device, a test strip, a test strip reader, and a tissue imager.

3. The telemedicine station of claim 2, wherein the blood sample analyzer is a microfluidic blood sample analyzer.

4. The telemedicine station of claim 1, wherein the one or more medical supplies comprises one or more of the following: pharmaceutical products, an ultrasound therapy device, an electrostimulation therapy unit, a drug delivery device, first aid supplies, and urine catheters.

5. The telemedicine station of claim 1, wherein the medical toilet further comprises a seat and a lid, and wherein the seat and lid comprise medical diagnostic devices.

6. The telemedicine station of claim 1, wherein the audiovisual communication device comprises a lockable barrier, wherein the lockable barrier is electronically connected to a remote healthcare facility, and wherein the lockable barrier can be unlocked either through the remote mechanism or the access permission.

7. The telemedicine station of claim 1, further comprising a first user identification system which unlocks the lockable door upon input of the access permission.

8. The telemedicine station of claim 7, wherein the first user identification system comprises one or more of the following: Bluetooth beacon proximity detection, identification of a personal identification code, radio frequency identification of a user's mobile device, and biometric verification.

9. The telemedicine station of claim 1, wherein the access permission comprises one or more of the following: a Bluetooth beacon a personal identification code, a radio frequency, and a biometric input.

10. The telemedicine station of claim 1, wherein the first cabinet comprises a wireless transceiver for detecting the presence of a radio frequency identification device in each of the first plurality of lockable compartments.

11. The telemedicine station of claim 1, wherein the second cabinet comprises a wireless transceiver for detecting the presence of a radio frequency identification device in each of the second plurality of lockable compartments.

12. The telemedicine station of claim 1, wherein the first cabinet comprises a first sensor, wherein the first sensor detects the presence or absence of objects within the first plurality of lockable compartments.

13. The telemedicine station of claim 12, wherein the first sensor comprises one or more of the following: a weight sensor, an optical sensor, and an acoustic sensor.

14. The telemedicine station of claim 1, wherein the second cabinet comprises a second sensor, wherein the second sensor detects the presence or absence of objects within the second plurality of lockable compartments.

15. The telemedicine station of claim 14, wherein the second sensor comprises one or more of the following: a weight sensor, an optical sensor, and an acoustic sensor.

16. The telemedicine device of claim 1, wherein the first plurality of lockable compartments and second plurality of lockable compartments comprise a one-way door through which medical supplies are inserted but not removed.

17. The telemedicine device of claim 1, wherein the first plurality of lockable compartments and the second plurality of lockable compartments comprise a refrigeration unit.

18. The telemedicine device of claim 1, wherein the audiovisual communication device is connected to a second audiovisual communication device, wherein the second audiovisual communication device is located within a remote healthcare facility.

19. The telemedicine device of claim 1, wherein the communications port transmits data from the at least one piece of diagnostic equipment to a user's electronic medical file.

20. The telemedicine device of claim 1, wherein the first cabinet and the second cabinet are combined into a single structure.
